(19) United States
(12) Patent Application Publication
(10) Pub. No.: US 2004/0049518 A1
(43) Pub. Date: Mar. 11, 2004

(54) Historical data recording and visualizing system and method

(75) Inventors: Serge Billieux, Carouge (CH); Abel Divin, Grandvaux (CH)

Correspondence Address: John MOETTELI, BUGNION S.A., Case Postale 375, GENEVA, 1211_GENEVA 12, CH

(73) Assignee: FinLab SA, Geneva (CH)

(21) Appl. No.: 10/278,000

(22) Filed: Oct. 22, 2002

Related U.S. Application Data
(60) Provisional application No. 60/345,354, filed on Oct. 22, 2001.

(51) Int. Cl. G06F 17/00

(52) U.S. Cl. 707/102

(57) ABSTRACT

A system and method is provided to input, store, and present business objects historical data representing a series of values and/or states taken by a variable and/or object, respectively, over a validity time period. Because the financial world bases its behavior on its perception of the future as well as on its understanding of the past, such a representation of data is more detailed and accurate and further facilitates both the implementation of software applications and the manipulation of time dependent data in these software applications.

### REFERENCE TO RELATED APPLICATIONS

This application claims priority to provisional patent application No. 60/345,354 of the same title, the content of which is incorporated herein by reference thereto.

### BACKGROUND OF THE INVENTION

The invention relates to systems and methods of recording and visualizing data, in particular, historical data in the business and financial sectors.

The invention involves object oriented concepts and UML diagrams, which are best understood after a review of S. Khoshatian and R. Abnous, Object Orientation Concepts, Languages, Databases, User interfaces, Wiley, 1990, and The Unified Method, Draft Edition (0.8) by Rational Software Corporation, October, 1995, the contents of which are incorporated herein by reference thereto.

In macroscopic terms, a business historical data recording and visualizing software application can be viewed as a program offering tools to manipulate business objects data. Designing a good business object model that reflects the real business world is the central issue in building a useful historical data recording and visualizing software application. An accurate model allows the user to quickly identify and look for relevant information and also helps him to better conceptualize abstract representations in the business world.

The state of business objects evolves with time. Therefore, when dealing with a business object, it is usual to keep track of its previous and/or last states. For example, for a given financial object of type “Fund”, it is quite usual to maintain a record of the identity of the previous administrator(s) in addition to the current administrator. However, it is of even greater use to keep continuous track of the changes in the state or the object and, thereby, be able to look at the object evolution in time. For instance, people who would like to invest in a certain fund ‘B’ will find it very interesting to know that, 5 years ago, the current administrator of Fund ‘B’ was actually the administrator of another Fund ‘A’ that went into bankruptcy.

To be comprehensive, a historical analysis business software application should register, store and help visualize business objects historical data, this being referred to as the problem of ‘business historical data recording and visualizing’. In addition, it is often useful to turn the clock back on system time and be able to reproduce the same reports. In this context, data stored after the chosen system date has no influence in the reporting. The system time is the time of the database. Each event in this time is data input-stamped by the date at which the input takes place. It is key not to confuse system time with business time, which is the ‘real’ time of the object that you want to study. For example, 20 years of a fund history (business time) can be input in the database within 10 minutes (duration in system time). Further, on Sep. 17, 2001 the user can input the information that, from Dec. 31, 1990 until Dec. 31, 2000, the administrator of a fund was the company X.

Despite the recognized value of a comprehensive solution, no general basis has been established for solving the problem of ‘business historical data recording and visualizing. Most software has tried to solve this problem in a manner that is subjective to the application and adapted to the type of objects to be covered by the application. This leads to a substantial loss in terms of both time spent in developing the solution and also the efficiency and the maintainability of the solution developed.

What is needed therefore is a better mechanism to characterize historical knowledge. Further, what is needed is a mechanism that simplifies historical data input and display in a comprehensible manner.

### SUMMARY OF THE INVENTION

A computerized system and method is provided. The system on which the method operates includes a processor, data storage, a database management system, input devices and a display device. The method includes three basic steps. In a first step, using a graphical user interface (GUI), a user inputs business objects historical data, including pseudo-static data representing a series of values and/or states that may be taken by a variable and/or object, respectively, over a validity time period in which there is one period for each value and/or state. The input is made via a data input graphical user interface. In a second step, the business objects historical data is stored at the command of the user. In a third step, such pseudo-static historical data is presented in visual form via the display device. The display device displays the pseudo-static data graphically as discrete segments over the validity time period, adjacent relevant supporting data such as start date and end date, source, source ranking, name of person who input the data, and description of the characteristic, among others.

In a feature of the invention, the system and method store and enable the visualization of business objects historical data by providing a typology (i.e., various “types” of ways of being a function of time) of business object characteristics in the time domain.

The financial world bases its behavior on its perception of the future as well as on its understanding of the past. An object of the invention therefore is to characterize events that have occurred in the past more thoroughly, thus better characterizing this classification of knowledge.

Another object of the invention is to provide a graphical user interface that simplifies data input and displays the input information in an easy to understand graphical manner.

### BRIEF DESCRIPTION OF THE DRAWINGS

FIG. 1 is a flow chart of the basic method of the invention.

FIG. 2 is a schematic diagram of the system of the invention.

FIG. 3 is a graphic representation of pseudo-static data.

FIG. 4 is a UML class representation of pseudo-static data.

FIG. 5 is a UML class diagram showing the relations of elements of the invention.

FIG. 6 is a UML class diagram of a pseudo-static field.

FIG. 7A is a UML class diagram of a pseudo-static dialog.

FIG. 7B is a UML class diagram of an alternate pseudo-static dialog.

FIG. 8 is a UML class representation of the pseudo-static input dialog.

FIG. 9 is a UML class representation of the pseudo-static field.

FIG. 10A is a screen print of an interface of the invention.

FIG. 10B is a screen print of a status window of the invention.

FIG. 10C is a input window for pseudo-static data.

FIG. 10D is a pseudo-static data display window.

FIG. 11 is a screen print of data for a representative fund.

FIG. 12A is a display window for the redemption scheme of a fund.

FIG. 12B is the redemption scheme represented in a pseudo-static display window.

FIG. 12C is a display of complex pseudo-static data.

FIG. 13A is a display of authorized country data related to a fund.

FIG. 13B is a pseudo-static display of authorized country data.

FIG. 14 is a screen print of a data interface for a particular fund.

FIG. 15 is a screen print of the source rankings for a particular fund.

### DETAILED DESCRIPTION OF THE PREFERRED EMBODIMENT

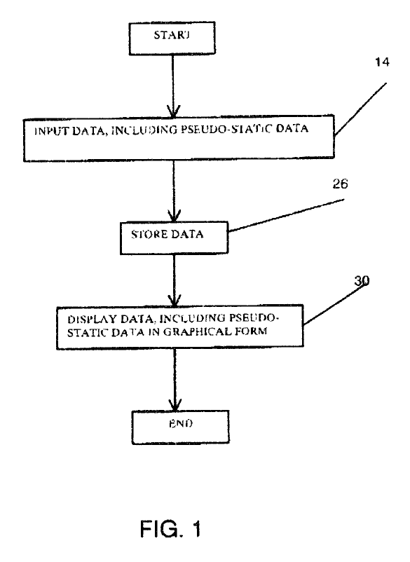

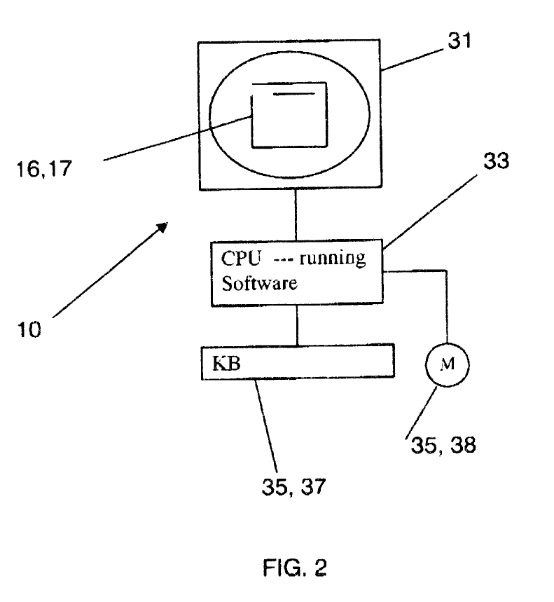

Referring now to FIG. 1, a computer system 10 (shown in FIG. 2) is encoded with a multisource historical data recording and visualizing method 12 capable of operation over a high speed communications network. The method 12, referred to as multisource because an attribute can take on different values depending on the source, includes three basic steps. In a first step 14, using a graphical user interface (GUI) 16 (shown) in FIG. 2), a user inputs business objects historical data, including pseudo-static data 18 representing a series of values and/or states that may be taken by a variable and/or object 20, respectively, over a validity time period 22 in which there is one period for each value and/or state. In a second step 26, the business objects historical data is stored at the command of the user. In a third step 30, such pseudo-static historical data 18 is presented in visual form via a display device 31 (shown in FIG. 2).

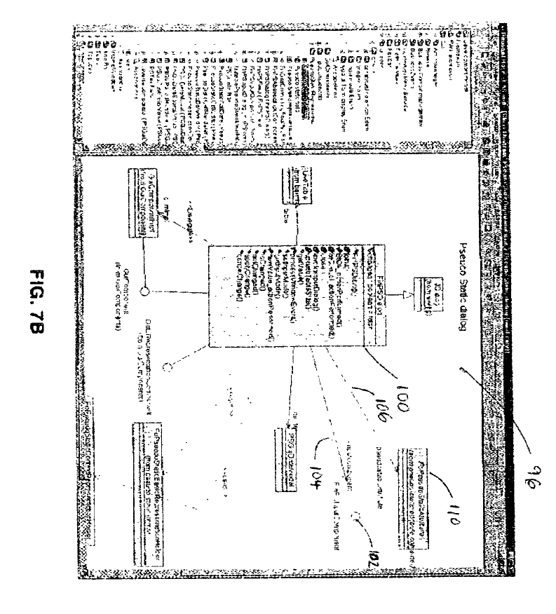

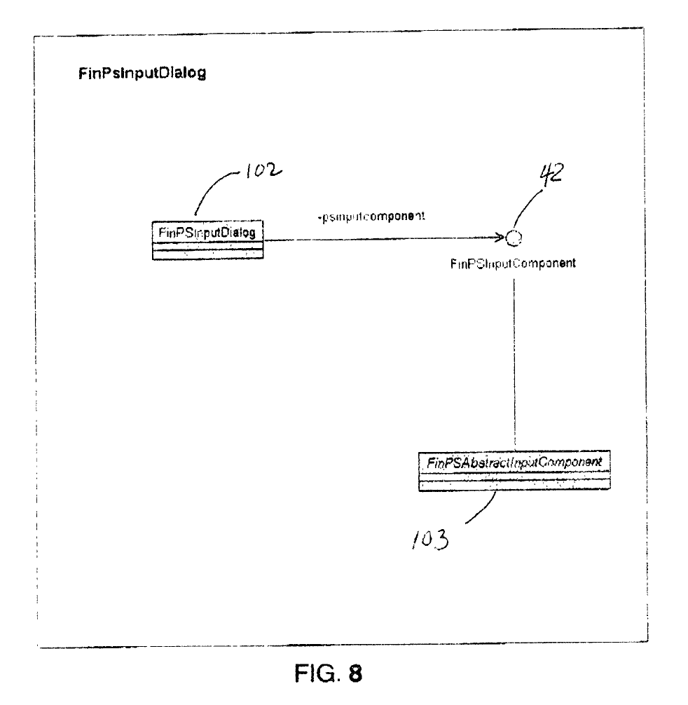

The display device 31 displays tire pseudo-static data 18 on screen 17 via the GUI 16 as discrete segments 19 (shown in FIG. 8B) over the validity time period 22, adjacent relevant supporting data such as start date 54 and end date 60, source 66, source ranking 67, name of person who input the data, description of the characteristic, among others.

The system 10 of the invention includes a microprocessor 33 which operates with a database management program, input devices 35 such as a keyboard 37 and a mouse 38 and the output display device 31. The method 12 of the invention relies on this pseudo-static data 16 as a key input and criteria used for making investment decisions on a fund, stock or other security. Pseudo-static data 18 is a category of information characteristic of a particular fund or security as each is defined by or associated with information that is valid only for a limited time period.

Pseudo-static data 18 has heretofore either been ignored or presented in footnote form only, and thus was not suitable for computer processing or display in a useful, simple to understand format.

The computerized method 12 of the invention is therefore made possible by abstracting the problem and explaining it in a manner sufficiently simple to be able implement it in a totally generic manner.

All “systems” (in a generic sense) are made up of many classes 40 and objects 24 that are described in a business object model “Objects” 24 are class instances. For example, Mr. Robinson is an instance of the class “Person”. System behavior is achieved through cooperation of the objects in the system. This business object model represents the world that the user wishes to analyze. This constitutes the medium by which the user can store, retrieve and manipulate information that is of interest for his study.

UML (Unified Modeling Language) is an attempt to standardize the artifacts of analysis and design for software development: semantic models, syntactic notation and diagrams, and so forth. It is therefore a useful way of characterizing data and representing data relationships.

At the user level, an object 42 is described by all its characteristics. A person has a name, an age and a certain number of colleagues, for example. The user wants to access these data regardless of the complexity of the underlying implementation.

Nevertheless, the implementation requires differentiation between:

(1) “attributes” 44 that are passive intrinsic characteristics (for example the name of a person).

(2) “methods” 46 that are pieces of logic that induce an action (method “stand up on object “person”) or return simple or complex values (method “age” on object “person”). The methods constitute the medium of communicating or interacting with objects 42.

(3) “relationships” that explain object business interactions. For example, an association relationship between a fund X and its management company B means that there is a link between objects defined between the associated classes (fund and company).

“Inheritance” defines a relationship among classes 40 where one class shares the structure and/or behavior of one or more classes. Technically methods 46 are used [symbol] to ge o set the value of an attribute 44.

To come back to the user level, all these data, as they are describing objects 42 of the real world, are all implicitly a function of business time 50 (among others factors). It is a goal of the method 12 to identify groups of attributes/methods/relationships that have a similar behavior as a function of time (business time 50). For this reason, in the remainder of this application, when mentioning attributes 44, this is meant to implicitly refer to attributes/methods/relationships, unless otherwise stated.

System Time

A new dimension that adds complexity to the business historical data problem is the ability to keep track of when the modification of the knowledge of the business history has been made and when and which user inputs data. Such inputs are made in system time”. This allows any user to introduce historical data at any system time: not only the actual last value of an attribute but also previous values.

For example, one may know today that 2 years ago the currency of a given asset had changed. If we modify existing past business historical data, we need to keep track of the time at which the change of the knowledge of the business history has been made if the start date of an attribute is D1 and is modified at date T1, following the principle of not permanently deleting any data, this means that the modification will result in the introduction of a new value D2 in the business object attribute business history. In reality, the implementation of the method 12 in software must be reminded that D2 replaces D1, in the sense that it is only the start date D1 that is modified. If the system time is set in the past after time T1, one should not see D1 but only D2. But if the system time is set before time T1, one should see D1.

Each attribute value of a given object is flagged with the date of input, user name and source name.

1.1 Static (S)/Pseudo-Static (PS)/Time Series (TS)

At least three groups of business time dependency exist:

1 No change at all during the object life (static, constant);

2 Change from time to time (pseudo-static) or piecewise constant; and

3 Simple function of time (time series).

1.1.1 Static Attributes

Static attributes 52 are valid forever in the real world, sometimes they are valid from a starting date 54. For example, a birth date is a static attribute 52. The presence of this information is continuous and constant in the real world.

1.1.2 Pseudo-static Attributes

Pseudo-static attributes 56 change values discretely. These values are valid for a period of time 22. For example the address, the name or the monthly salary of a person is pseudo-static. Depending on which business is involved, the time resolution has to be determined and the granularity decision is implementation dependant. For example, in the present invention, time granularity is set at one day.

The concept of pseudo-static data is introduced in order to enable the method 12 to manage object attributes 44 that can change over time but change just sometimes, in a step wise fashion, during the entire object life (piece-wise constant). So when an attribute 44 takes a new value, previous values remain as historical data.

As already mentioned a pseudo-static attribute 56 takes a value along with a validity period 22 inscribed by a start date 54 and an end date 60. In some cases, the start date 54 of a given value could be the end date 60 of the previous value.

As for the past, there are two ways to navigate it. One is to go by the system time, indicating to the application that all user inputs after this given date should be ignored. The second is to go by the business time allowing the user to navigate in the global business history of the business objects 42.

Within the group of pseudo-static attributes 56 are mono-valued and multi valued attributes. An example of a mono-valued attribute is base currency—a fund can only have one base currency at a time just as a person can only wear one pair of shoes at a time. An example of multi-valued attributes is multiple promoters, or children, just as a fund can have multiple promoters and a person can have many children. These constraints are summarized as follows:

| | | | | |
|---|---|---|---|---|
| Min | 0 | 0 | 1 | 1 |
| Max | 1 | N | 1 | N |
| | Optional | Optional | Mandatory | Mandatory |

Attributes 44 where the minimum is 0 are optional in the sense that the user is allowed not to register any value, while those for which the minimum is 1 are mandatory.

1.1.3 Time Series Attributes (TS)

An attribute 44 that can conceptually and potentially change value over every single infinitesimal time period constitutes a time series attribute 62 and is de facto a numerical attribute in contrast to pseudo-static attributes 56, each value taken by the [symbol] series attribute 62 is potentially valid only at a given point in time. Even if, in some cases, it can be constant over a period of time, these situations are coincidental and therefore not useful. For example the Net Asset Value (NAV) of a fund is a time series attribute 62 of an object fund. Note that it is key not to confuse time-series sampling and pseudo-staticity. Monthly, weekly or daily values of a fund's NAV are just the last values observed in a month, a week or a day. It should be noted that time series attributes 62 are simple functions of time only, meaning that at a given date, the function returns a simple numerical value.

1.1.4 Other Attributes

Some “attributes” 44 (as globally defined) are more complex functions of many more parameters than just time. For example, the return of a fund is ‘twice’ a function of time because it is calculated over a period of time with a sampling frequency. It depends, among other things, on a start date 54 and end date 60. These attributes 44 are neither static 52, pseudo-static 56 nor time-series 62. As far as the instant implementation is concerned, these cases invoice algorithms called on objects 42 with some or all the parameters being set in an ad hoc manner by the user and thus are not readily adaptable to computer processing.

1.2 Sources

In the same period of time, a multi-source attribute 64 is an attribute 44 that could take different values depending on the sources 66, leaving the user the problem of choice.

For example, one source 66 might claim that in 1999, the administrator of company Y was Mr. X, while another would claim it was Mr. Z. Similarly, one source 66 might claim that the price for IBM NAV was $100—while another would say it was $101. Therefore, the system 10 and method 12 of the invention deals with non identical values that come concurrently from a variety of external sources 66.

The source 66 can be <<local>> or <<external>> depending on local user input or external data feed such as BLOOMBERG™ REUTERS™, TASS, among others. The source 66 is defined as a legal entity and can, of course, be a user of the system 10 and method 12 of the invention.

The source dimension adds another dimension of complexity to the solution of the pseudo-staticity problem and is taken into account in the method 12 of invention. The additional dimension of the source can also affect static and time series data.

1.2.1 Data Source Ranking (DSR)

For those attributes 44 for which a ranking of preferences of data sources 66 is defined, the ranking is used for the retrieval of the value of the attributes for display. Otherwise, the system 10 defines a preferred data source ranking. The system 10 should be able to take care of that ranking 70 when retrieving a given value. Various [symbol] apply here, notably with respect to the time period 22 for which a given ranking 70 is valid.

Time Series attributes 62 can come from various sources 66. Each data item 72 is labeled by its source 66. For one TS data item (NAV for example) and for the same value date, one can have therefore many data items 72 coming from different sources 66.

The Data Source Ranking (DSR) algorithm 74 is a total order relation defined on the data sources 66. The first data source 66 is the preferred one, the second data source is the second preferred and so on. This new feature gives the user the ability to decide among all sources 66, specifically, which one is considered the best in terms of the quality of the values.

### Chronological Order

By default, the hierarchy of sources 66 is chronological meaning that the first registered value source is considered to be the best one. An old source is most of the time, better known. A new data source 66 is first considered low quality until otherwise qualified by, for example, comparison with the quality criteria of other sources.

The DSR is defined at the business object level 42. However, we can change this exiting hierarchy at a deeper level for example for a given attribute 44 or TS data item 72. The hierarchy of DSR is itself pseudo-static in the system time, meaning that the hierarchy can be changed over time.

1.2.2 Optimal Aggregated Series (OAS)

At the data processing level 76, there is a need for choosing from among data items 72 an item that is considered the best quality data item, implicitly applying a type of Data Source Ranking. The algorithm is called the Optimal Aggregated Series (OAS) 80. This term is applicable both to time series and pseudo-static attributes 62 and 56 respectively.

1.3 Example

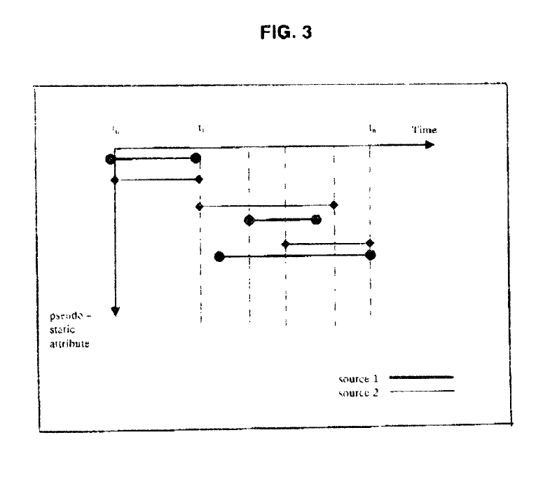

Referring now to FIG. 3, an example of a two source pseudo static attribute 56 is shown. Between t₀ and t₁, one can choose source one 82 as the preferred source, then between t₁ and t₀ choose source two 84. If a mandatory attribute value, the value should be defined at least one from each source for every time interval 22. As there are multiple values from various sources 66 for a given time interval 22, a hierarchy 70 of sources would be defined.

1.4 Design Issues

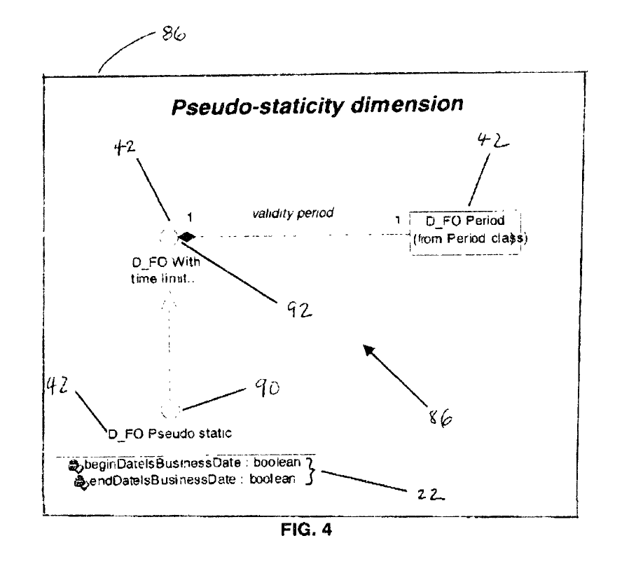

Referring now to FIG. 4, in a UML class diagram 86, the concept of pseudo-staticity is represented by a collection of objects 42 representing the attribute 44. Each object 42 of the collection represents one of the values of the attribute 44 defined over a period of time 22. A “D_FO Pseudo Static” class 90, which adds the notion of a “business date”, inherits from interface “D_FO with time limit” 92. Class “D_FO with time limit” 92 represents the notion of time limited information. This notion is implemented with the one-to-one aggregation with class “D_FO Period 94. Finally, class “D_FO Period” 94 represents the concept of an arbitrary time scale period.

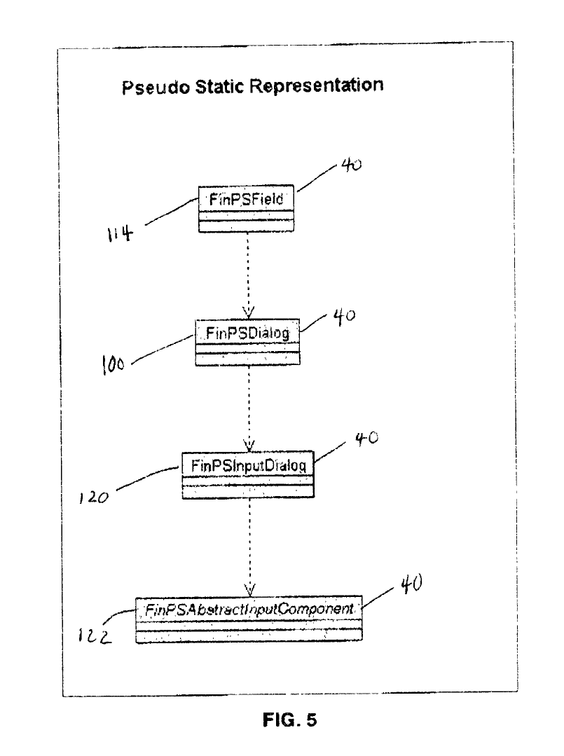

Referring now to FIG. 5, the usages relation between the main classes 40 used to display and edit pseudo-static attributes 56 is shown. The “FinPSField” class 114 is used to display a summarized view of a pseudo-static attribute 56. It may use “FinPSDialog” 100 to display a detailed view of the attribute 44 it requested. The “FinPSDialog” 100 uses a “FinPSInputDialog” 120 that provides generic editing functions that apply to all types of pseudo-static attributes 56. A specialized class that inherits from “FinPsAbstractInputComponent” 122 used to offer dedicated input features to specific sub types of attributes 44. Essentially, this figure shows how the different classes work together. The FinPSDialog 100 displays all data/period pair of the pseudo static attribute 56 in an intuitive interface that shows how the data has evolved over the time. The user may edit the time periods 22 by simply clicking in the corresponding period frame. To enter new data, the FinPsDialog 100 invokes the FinPsInputDialog 120. The FinPsinputDialog 120 dialog lets the user enter a new time period 22 and use a FinPsAbstractInputComponent 122 to provide a specialized interface for editing the actual data item.

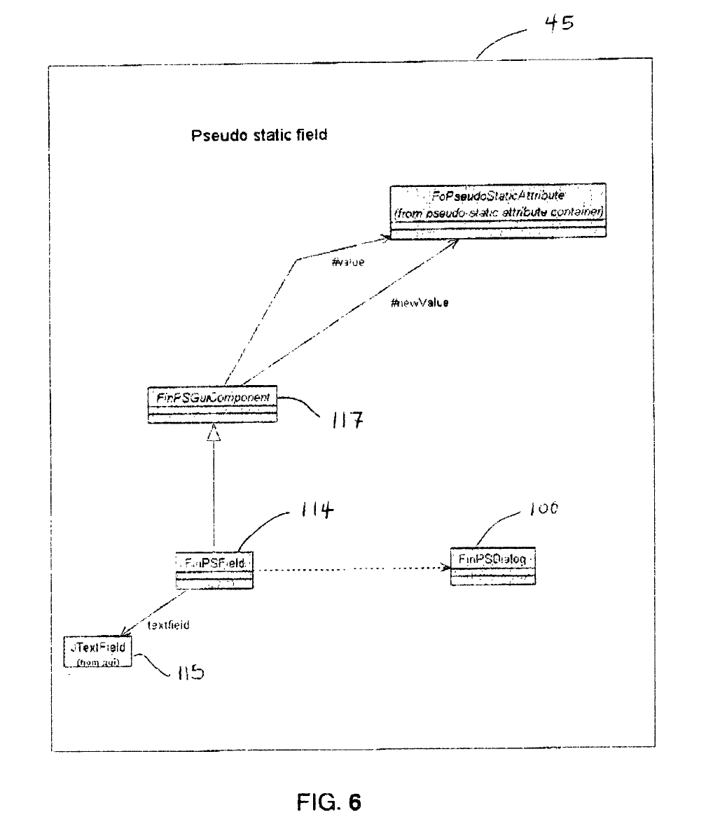

Referring now to FIG. 6, a UML class diagram 45 illustrating the operation of the FinPSField 114 is shown. The FinPSField 114 uses a standard java Swing JtextField 115 to display the summarized view of the pseudo static attribute 56. The FinPsField 114 is used only to display the summarized view and therefore relies on a FinPSDialog 100 to provide editing features. The FinPsField 114 is a specialized FinPSGuiComponent 117. It keeps two separate attributes (value and newvalue) to allow the user to revert to his changes after an edit.

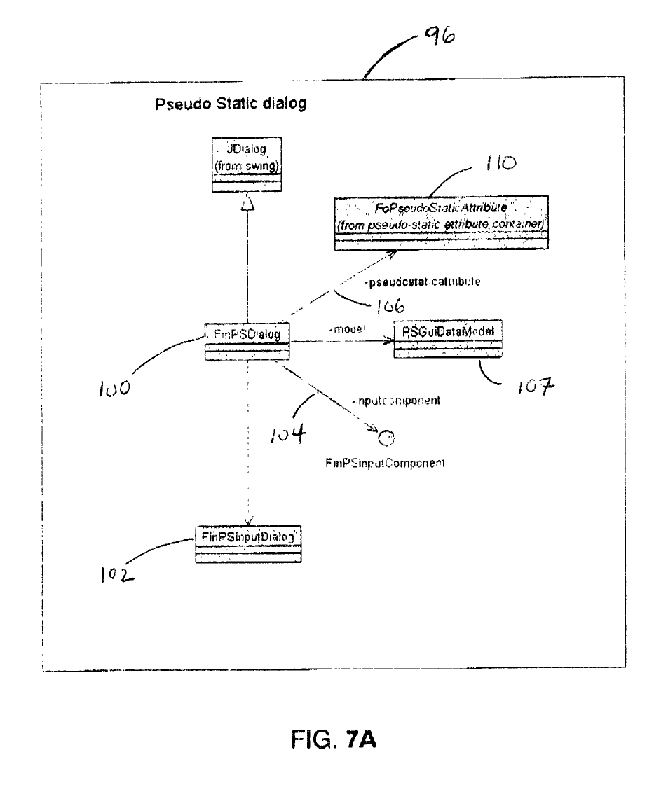

Referring now to FIGS. 7A and 7B, a conceptual representation of a java Swing GUI dialog window 96 is shown. This GUI dialog window 96 allows the editing or creation of pseudo-static attributes 56. From the diagram, the “FinPSDialog” 100 is the [symbol] class. The method 12 can handle any subtypes of pseudo-static attributes 56 when the appropriate “FinPSInputComponent” 102 is provided through the “inputcomponent” relation 104. The private relation “pseudostaticattribute” 105 from “FinPSDialog” class 100 to “FoPseudoStaticAttribute” 110 represents the relation between the “editor” and the “data”.

The FinPSDialog 100 uses a data model class (PSGuiDataModel 107) that handles complex time data structures (e.g., merging of consecutive periods, split of periods, enforcement of periods business rules).

Referring now to FIG. 8, the FinPsInput dialog 102 is used to enter or edit data period pair. The FinPSInputDialog 102 handles the period input directly and delegates the data input to a FinsPsInputComponent 103. A FinPsInputComponent 103 is an interface (i.e., an object 42 that describes a behavior) for that reason the actual work is done by a derived class (not show on figure) of FinPSAbstractComponent FinPsAbstractComponent provides the behavior defined by FinPSInputComponent 103 and the derived class provides the user interface required for the specific pseudo static attribute 56. The advantage of this architecture is that one has to provide a class that inherits from FinPSAbstractComponent to be able to use the whole viewing/editing facility of pseudo static attribute 56 described above.

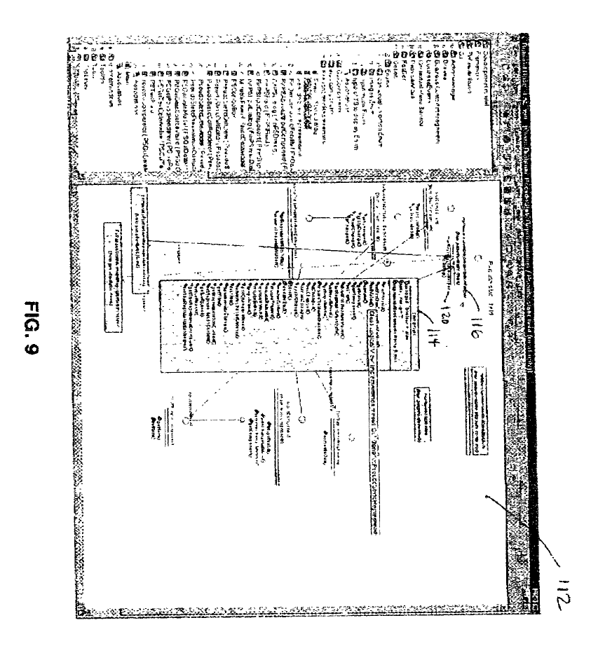

Referring now to FIG. 9, a conceptual representation of a java Swing GUI field window 112 allows display of pseudo-static attributes 56. From the figure, the “FinPSField” 114 is the core class. This class 114 may handle any subtype of pseudo-static attribute 56 when the correct “FoPseudoStaticRepresentationHelper” 116 is provided through the “theRepresentationhelper” relation 120.

1.5 Graphical User Interface

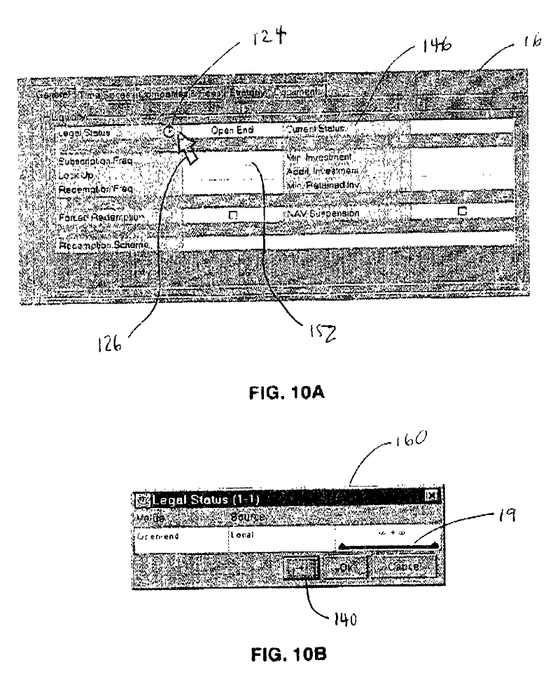

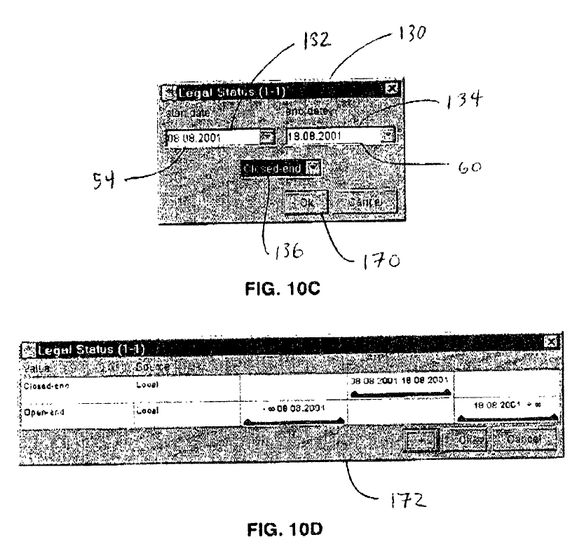

Referring now to FIGS. 10A-10B, the interface 16 is designed to handle and visualize pseudo-static values has been developed. The microprocessor 33 controls the pixel arrangement on the screen 17 of the display device 31 so as to display a clock shaped icon 124 activateable by a mouse cursor 126 displayed and moveable on the screen according to the inputs of a user. Placement of the mouse cursor 126 over the clock shaped icon 124 launches an input window 130 having start and end date fields 132 and 134 respectively, and a characteristic field 136. Clicking within such fields 132, 134 or 136 enables the user to input start and end date data 54 and 60, respectively, and time characteristic data 144 such as open or closed over time.

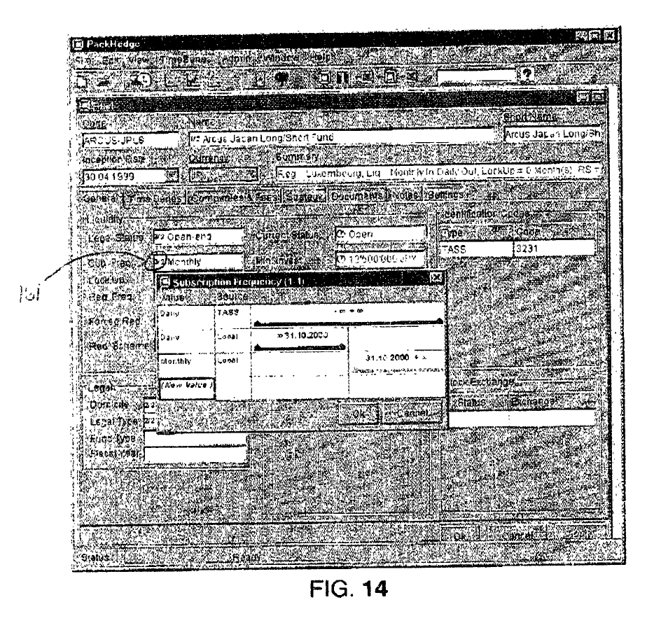

Referring to FIG. 10B, the interface 16 further has a status field 146, which, when activated and pressed using the cursor 126 displays a status window 160 showing the legal status over time. Further, a numeric indicator 161 (shown in FIG. 14), indicates whether the data is multi-source, the indicator further indicating the number of sources 66 (in this case, the number is 2).

Pseudo-static values are introduced into the interface 16 in the following manner. The mouse cursor 126 is positioned in desired text field 152 as usual (the Clock shaped icon 124 appears indicating the attribute is pseudo-static 56). The user clicks inside the field 152 in order to position cursor 126 in the text field (editing of current value). If the user clocks on the icon 124, the system 10 and method 12 of the invention then presents a window 160 (shown in FIG. 10B), indicating the attribute business history, which, as a default, has a legal status that is open-ended over time. The user is able to click the “+” button 140 to add a new value, upon such action, the window 130 appears to enable the selection of the time interval and the new attribute value 136. In the example of FIG. 10C an interval from Aug. 8, 2001 to Aug. 18, 2001 has been chosen to inform the system that during this time interval the legal status was closed-ended.

Referring now to FIG. 10D, when a user clicks “OK” 170, a result window 172 shows the new legal status over time.

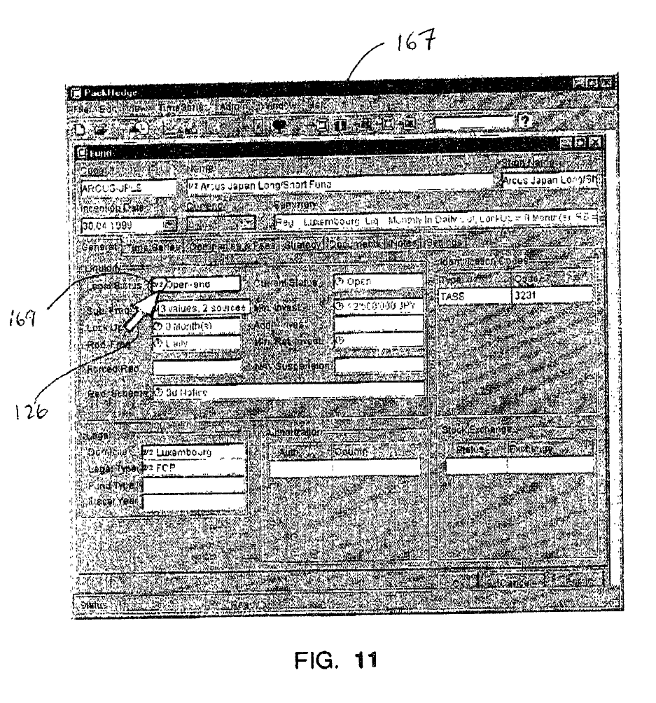

Referring now to FIG. 11, characteristic data associated with the ARCUS-Japan Long/Short fund is shown in a data interface 167. A numeric indicator “3/2” 169 displays three values from two sources 66 when the cursor 126 hovers over the indicator.

1.5.1 Pseudo-Static Attribute

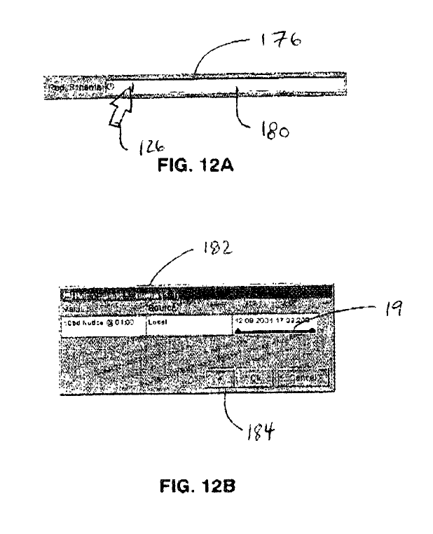

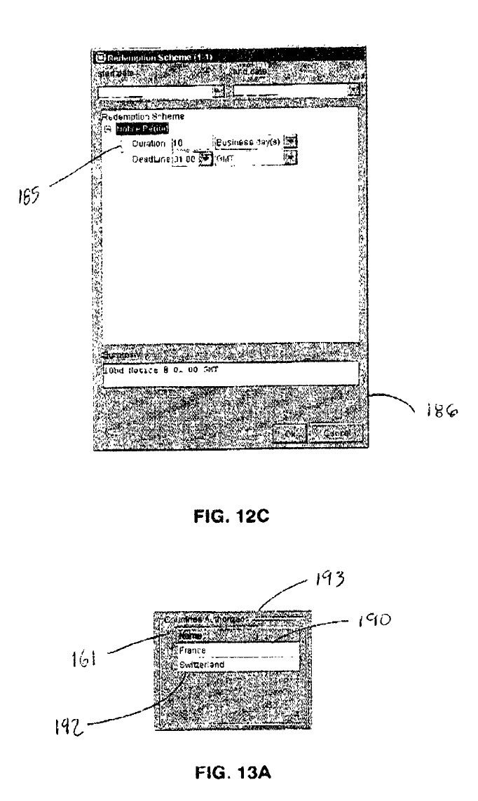

Referring now to FIGS. 12A-12C complex mono-valued pseudo-static attributes seen as the Redemption Scheme of a fund are represented in a display 176 (see FIG. 12A in particular).

By clicking inside the field 180 in order to position the cursor 126 in the text field [symbol] edit the current value), the pseudo-static module is called up and displays the fund or business history 182 according to its redemption scheme, as shown in FIG. 12B.

By clicking on button “+” 184 to add a new value, the input window 186 shown in FIG. 12C is displayed in order to permit input of the complex structure for a given interval of time. A structured tree 185 is shown in which pseudo-static data is associated with another level of pseudo-static data.

1.5.2 Multi-valued Pseudo-Static Attributes

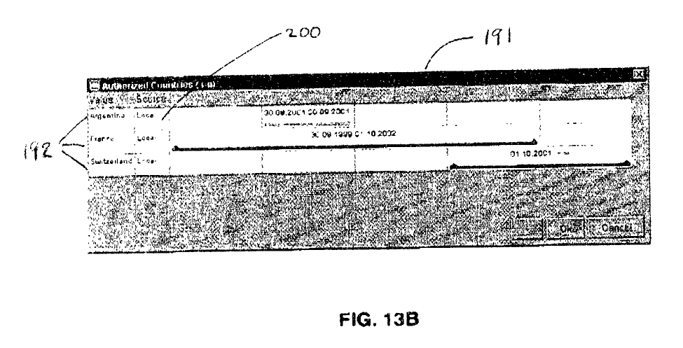

Multi valued pseudo-static attributes 190, such as the countries 192 in which sale of a fund is authorized, are represented in the interface 193 as shown in FIG. 13A.

Referring now to FIG. 13B, by clicking on the 3/1 indicator 161 (FIG. 13A) that specifies that there are three values 196 from one source 66 (‘local’ in this case) the pseudo-static display window 191 is opened to show the business history. From this example, we see that only two countries 192 are currently authorizing sale of this fund (France/Switzerland) but that in the past, Argentina had also authorized the sale of this fund.

Referring now to FIG. 14, application of DSR for selecting the best information to display is shown. According the DSR defined for this fund, because no BLOOMBERG™ data is available, and FINLAB™ data is said to be better than TASS data, the Subscription frequency of this fund is displayed to be MONTHLY as the user and the system is considered to be running at a date later than Oct. 31, 2000.

Illustration of the Data Source Ranking

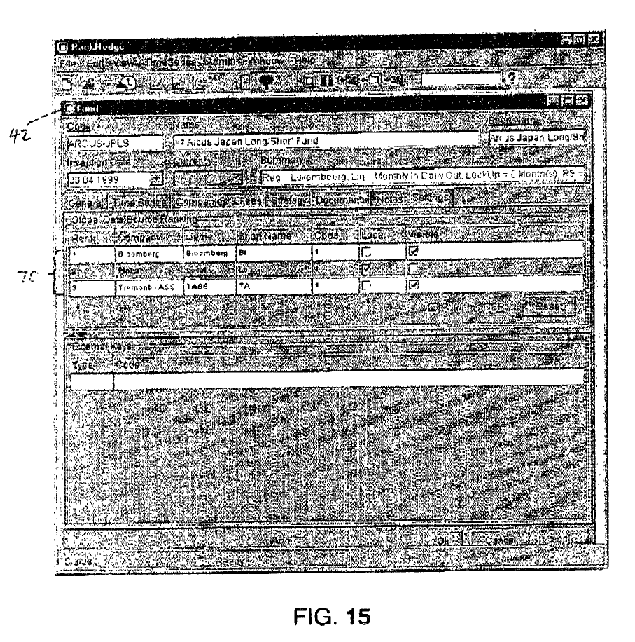

Referring now to FIG. 15, the user can define for each object 42 (again, in this example the fund ARCUS JAPAN Long Short) and the data source ranking 70 that defines the preference with which data will be searched in order to display the best available data for each attribute 44 of the object 42. As already mentioned, BLOOMBERG™ data is defined to be better than FINLAB™ data, being itself better than TASS data.

A system 10 and method 12 has been shown to characterize events that have occurred in the past more thoroughly, thus better characterizing this classification of knowledge. Further, a graphical user interface has been shown that simplifies data input and displays the input information in an easy to understand graphical manner.

In an advantage of the invention, the system 10 and method 12 present an exhaustive yet simple manner of how business time can influence business data.

In another advantage, the invention provides a user-friendly way to register and visualize historical business data in the case of pseudo-static attributes 56.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of this invention being limited only by the appended claims.

What is claimed is:

1. A computerized medium encoded with a computerized method, the method including the steps of:
a. inputting of business objects historical pseudo-static data representing a series of values and/or states that may be taken by a variable and/or object, respectively, over a validity time period in which there is one period for each value and/or state;
b. storing such business objects historical data; and
c. presenting such business objects historical data in visual form via a display device.

2. The medium of claim 1, wherein the visual form is a validity time-source graph in which segments of validity time delimited by validity dates are displayed in a column or row which corresponds to an associated source, identified in the graph.

3. The medium of claim 1, wherein the storing step stores data in a data structure in which additional information associated with the value and its validity time period may be input, the additional information being selectively presentable in visual form.

4. The medium of claim 1, wherein the method applies integrity rules on a set of associated validity time periods depending on the valuation of the variable and/or object, whether mono-valued, multi-valued, optional or mandatory.

5. A computerized method including the steps of:
(a) inputting of business objects historical pseudo-static data representing a series of values and/or states that may be taken by a variable and/or object, respectively, over a validity time period in which there is one period for each value and/or state,
(b) storing such business objects historical data; and
(c) presenting such business objects historical data in visual form via a display device.

6. The method of claim 5, wherein the visual form is a validity time-source graph in which segments of validity time delimited by validity dates are displayed in a column or row which corresponds to an associated source, identified in the graph.

7. The method of claim 5, wherein the storing step stores data in a data structure in which additional information associated with the value and its validity time period may be input, the additional information being selectively presentable in visual form.

8. The method of claim 5, wherein the method applies integrity rules on a set of associated validity time periods depending on the valuation of the variable and/or object, whether mono-valued, multi-valued, optional or mandatory.

9. An interface for inputting data, the interface generated by a microprocessor controlling the pixel arrangement on a display screen so as to display a clock shaped icon activateable by a mouse cursor displayed and moveable on the screen according to the inputs of a user, wherein placement of the mouse cursor over the clock shaped icon launches an input window having start and end date fields, and a characteristic field, and wherein clicking within such fields enables the user to input start and end date data and time characteristic data such as open or closed over time.

10. The interface of claim 9, wherein, the input window further has a button which, when activated and pressed using the cursor, launches an input window allowing the user to input start and end times and a new attribute value.

11. The interlace of claim 9 wherein the input window further has a result icon, which, when activated and pressed using the cursor displays the status over time.

12. The interface of claim 9, wherein a numeric indicator indicates whether the data is multi-source, the indicator further indicating the number of sources.
